(19) United States
(12) Patent Application Publication
(10) Pub. No.: US 2015/0155774 A1
(43) Pub. Date: Jun. 4, 2015

(54) SURGING CURRENT SUPPRESSION CIRCUIT

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: KE-YOU HU, Shenzhen (CN)

(21) Appl. No.: 14/552,180

(22) Filed: Nov. 24, 2014

(30) Foreign Application Priority Data
Nov. 30, 2013 (CN) 201310621807.2

(51) Int. Cl. H02M 1/32; H02M 3/158

(52) U.S. Cl. CPC H02M 1/32; H02M 3/158

(57) ABSTRACT

A surging current suppression circuit includes a voltage regulating circuit and a switch circuit. The voltage regulating circuit receives a first DC voltage, and converts the first DC voltage to a second DC voltage. The switch circuit receives the second DC voltage, and outputs a working current according to the second DC voltage. The switch circuit outputs the working current to the electronic device when the working current is lower than a rate current of the electronic device. The working current is grounded via the switch circuit when the working current is higher than the rate current of the electronic device; and the electronic device can not receive the working current when a surging current occurred.

### CROSS-REFERENCE TO RELATED APPLICATIONS

This application claims priority to Chinese Patent Application No. 201310621807.2 filed on Nov. 30, 2013, the contents of which are incorporated by reference herein.

### FIELD

The subject matter herein generally relates to a surging current suppression circuit.

### BACKGROUND

Voltage regulator devices are widely used on printed circuit boards to provide required direct voltages for electronic components. The voltage regulator device sometimes malfunctions which leads to a surging current. The electronic components tend to be damaged by the surging current.

### BRIEF DESCRIPTION OF THE DRAWINGS

Implementations of the present technology will now be described, by way of example only, with reference to the attached figures.

FIG. 1 is a block diagram of an embodiment of a surging current suppression circuit.

FIG. 2 is a circuit diagram of the surging current suppression circuit of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

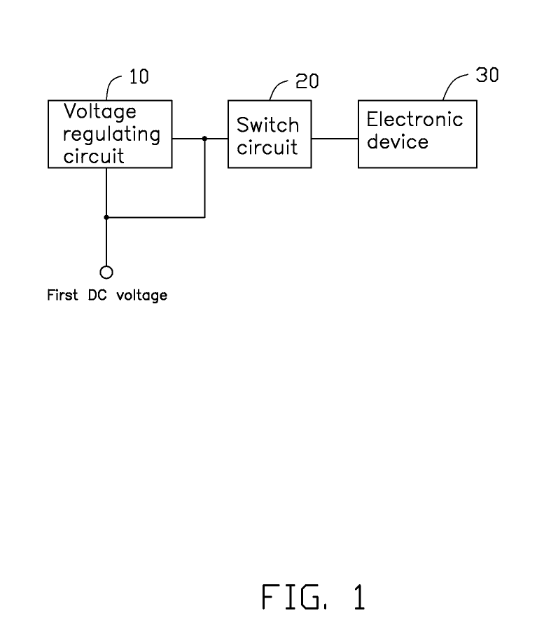

FIG. 1 illustrates a surging current suppression circuit in accordance with an embodiment. The surging current suppression circuit includes a voltage regulating circuit 10 and a switch circuit 20. The voltage regulating circuit 10 provides working current to an electronic device 30 via the switch circuit 20.

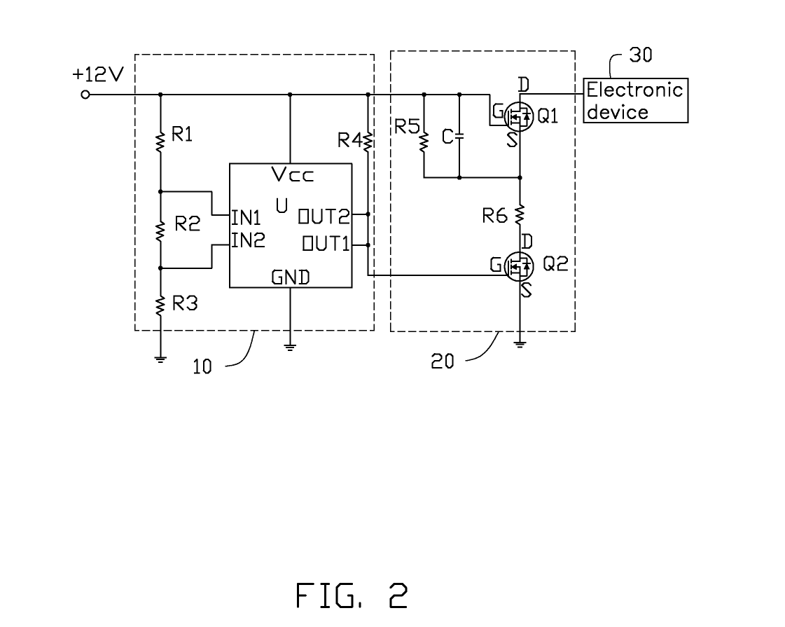

FIG. 2 illustrates that the voltage regulating circuit 10 includes a voltage regulating chip U, a first resistor R1, a second resistor R2, a third resistor R3, and a fourth resistor R4. The voltage regulating chip U includes a first voltage input terminal IN1, a second voltage input terminal IN2, a first voltage output terminal OUT1, a second voltage output terminal OUT2, a power terminal VCC, and a ground terminal GND.

The first voltage input terminal IN1 receives a first DC voltage via the first resistor R1. The first voltage input terminal IN1 is electrically coupled to the second voltage input terminal IN2 via the second resistor R2. The second voltage input terminal IN2 is grounded via the third resistor R3. The power terminal VCC receives the first DC voltage. The power terminal VCC is electrically coupled to the first voltage output terminal OUT1 and the second voltage output terminal OUT2 via the fourth resistor R4. In at least one embodiment, the first DC voltage is +12V.

The switch circuit 20 includes a first MOSFET Q1, a second MOSFET Q2, a fifth resistor R5, a sixth resistor R6, and a capacitor C. Each of the first MOSFET Q1 and the second MOSFET Q2 includes a gate, a source, and a drain.

The gate of the first MOSFET Q1 receives the first DC voltage. The gate of the first MOSFET Q1 is electrically coupled to the source of the first MOSFET Q1 via the fifth resistor R5 and the capacitor C respectively. The drain of the first MOSFET Q1 is electrically coupled to the electronic device 30. The gate of the second MOSFET Q2 is electrically coupled to the first voltage output terminal OUT1 and the second voltage output terminal OUT2. The source of the second MOSFET Q2 is grounded. The drain of the second MOSFET Q2 is electrically coupled to the source of the first MOSFET Q1 via the sixth resistor R6. In at least one embodiment, the first MOSFET Q1 and the second MOSFET Q2 are N-channel MOSFETs.

In use, the +12V first DC voltage is divided into a first driving voltage and a second driving voltage by the first resistor R1, the second resistor R2, and the third resistor R3. The first driving voltage and the second driving voltage are provided to the first voltage input terminal IN1 and the second voltage input terminal IN2. The voltage regulating chip U outputs a second DC voltage at the first voltage output terminal OUT1 and the second voltage output terminal OUT2 according to the first driving voltage and the second driving voltage. The second DC voltage generates the working current at the source of the first MOSFET Q1 via the fourth resistor R4 and the fifth resistor R5. In at least one embodiment, the second DC voltage is variable from +10.8V to +13.2V.

When the working current provided to the electronic device 30 is lower than a rate current of the electronic device 30, the first voltage output terminal OUT1 and the second voltage output terminal OUT2 outputs a low voltage level second DC voltage. The gate of the second MOSFET Q2 receives the low voltage level second DC voltage. The second MOSFET Q2 turns off. The gate of the first MOSFET Q1 receives the +12V first DC voltage. The first MOSFET Q1 turns on. The electronic device 30 receives the working current via the first MOSFET Q1, the fourth resistor R4 and the fifth resistor R5.

When the working current provided to the electronic device 30 is higher than the rate current of the electronic device 30, the first voltage output terminal OUT1 and the second voltage output terminal OUT2 outputs a high voltage level second DC voltage. The gate of the second MOSFET Q2 receives the high voltage level second DC voltage. The second MOSFET Q2 turns on. The gate of the first MOSFET Q1 receives the +12V first DC voltage. The first MOSFET Q1 turns on. The working current is grounded via the sixth resistor R6 and the second MOSFET Q2. The electronic device 30 can not receive the working current when a surging current occurred. The electronic device 30 is protected from being damaged.

The embodiments shown and described above are only examples. Many details are often found in the art such as the other features of a surging current suppression circuit. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A surging current suppression circuit for an electronic device comprising:
a voltage regulating circuit configured to receive a first DC voltage, and convert the first DC voltage to a second DC voltage; and
a switch circuit configured to receive the second DC voltage, and output a working current according to the second DC voltage;
wherein, the switch circuit outputs the working current to the electronic device when the working current is lower than a rate current of the electronic device; and
wherein, the working current is grounded via the switch circuit when the working current is higher than the rate current of the electronic device; and the electronic device can not receive the working current when a surging current occurred.

2. The surging current suppression circuit of claim 1, wherein the switch circuit comprises a first switch and a second switch; each of the first switch and the second switch comprises a first terminal, a second terminal, and a third terminal; the first terminal of the first switch receives the first DC voltage; the second terminal of the first switch is electrically coupled to the third terminal of the second switch; the third terminal of the first switch outputs the working current; the first terminal of the second switch receives the first DC voltage; and the second terminal of the second switch is grounded.

3. The surging current suppression circuit of claim 2, wherein the second switch turns off when the working current provided to the electronic device is lower than the rate current of the electronic device; the first switch turns on; and the electronic device receives the working current from the third terminal of the first switch.

4. The surging current suppression circuit of claim 3, wherein the second switch turns on when the working current provided to the electronic device is higher than the rate current of the electronic device; the first switch turns on; the working current is grounded via the second switch; and the electronic device can not receive the working current from the third terminal of the first switch.

5. The surging current suppression circuit of claim 4, wherein a first MOSFET and a second MOSFET are N-channel MOSFETs; and the first terminal, the second terminal, and the third terminal are gate, source, and drain respectively.

6. The surging current suppression circuit of claim 5, wherein the voltage regulating circuit comprises a voltage regulating chip, a first resistor, a second resistor, and a third resistor; the voltage regulating chip comprises a first voltage input terminal, a second voltage input terminal, a first voltage output terminal, and a second voltage output terminal; the first voltage input terminal receives the first DC voltage via the first resistor; the first voltage input terminal is electrically coupled to the second voltage input terminal via the second resistor; and the second voltage input terminal is grounded via the third resistor.

7. The surging current suppression circuit of claim 6, wherein the switch circuit further comprises a fifth resistor; and the first terminal of the first switch is electrically coupled to the second terminal of the first switch via the fifth resistor.

8. The surging current suppression circuit of claim 7, wherein the first DC voltage is +12V; and the second DC voltage is variable from +10.8V to +13.2V.

9. A surging current suppression circuit for an electronic device comprising:
a voltage regulating circuit configured to receive a first DC voltage, and convert the first DC voltage to a second DC voltage; and
a switch circuit comprising a first switch and a second switch;
wherein the switch circuit is configured to receive the second DC voltage, and output a working current according to the second DC voltage;
wherein, the second switch turns off when the working current provided to the electronic device is lower than a rate current of the electronic device; the first switch turns on; and the electronic device receives the working current from a third terminal of the first switch; and
wherein, the second switch turns on when the working current provided to the electronic device is higher than the rate current of the electronic device; the first switch turns on; the working current is grounded via the second switch; and the electronic device can not receive the working current from the third terminal of the first switch.

10. The surging current suppression circuit of claim 9, wherein each of the first switch and the second switch comprises a first terminal, a second terminal, and a third terminal; the first terminal of the first switch receives the first DC voltage; the second terminal of the first switch is electrically coupled to the third terminal of the second switch; the third terminal of the first switch outputs the working current; the first terminal of the second switch receives the first DC voltage; and the second terminal of the second switch is grounded.

11. The surging current suppression circuit of claim 9, wherein a first MOSFET and a second MOSFET are N-channel MOSFETs; and a first terminal, a second terminal, and a third terminal are gate, source, and drain respectively.

12. The surging current suppression circuit of claim 11, wherein the voltage regulating circuit comprises a voltage regulating chip, a first resistor, a second resistor, and a third resistor; the voltage regulating chip comprises a first voltage input terminal, a second voltage input terminal, a first voltage output terminal, and a second voltage output terminal; the first voltage input terminal receives the first DC voltage via the first resistor; the first voltage input terminal is electrically coupled to the second voltage input terminal via the second resistor; and the second voltage input terminal is grounded via the third resistor.

13. The surging current suppression circuit of claim 12, wherein the switch circuit further comprises a fifth resistor; and the first terminal of the first switch is electrically coupled to the second terminal of the first switch via the fifth resistor.

14. The surging current suppression circuit of claim 13, wherein the first DC voltage is +12V; and the second DC voltage is variable from +10.8V to +13.2V.
